(19) United States
(12) Patent Application Publication
(10) Pub. No.: US 2006/0017028 A1
(43) Pub. Date: Jan. 26, 2006

(54) Radiation image detector and radiation image generating system

(75) Inventors: Hiromu Ohara, Tokyo (JP); Yasuaki Tamakoshi, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/179,869

(22) Filed: Jul. 12, 2005

(30) Foreign Application Priority Data
Jul. 21, 2004 (JP) 2004-212931

(51) Int. Cl. G21K 4/00

(52) U.S. Cl. 250/580

(57) ABSTRACT

The radiation image detector having: a radiation image obtaining section to detect radiation irradiated and obtain a radiation image data; a communication unit to transmit the radiation image data to an external apparatus; a storing section attachment part which is capable of removably holding a storing section for storing the radiation image data, and causes the attached storing section to preserve the radiation image data obtained by the radiation image obtaining section; and a control unit that to select whether to transmit the radiation image data from the communication unit or to transmit the radiation image data by using the storing section, wherein the control unit changes over a transmission mode for transmitting the radiation image data to the external apparatus based on a result of the selection.

### BACKGROUND OF THE INVENTION

1. Field of the Invention

The present invention relates to a radiation image detector for detecting a radiation image as represented by an X-ray image and a radiation image generating system for generating a radiation image using the radiation image detector.

2. Description of the Related Art

So far, in a medical diagnosis, a radiation image which is obtained by irradiating a radiation such as an X-ray or the like to a subject and by detecting an intensity distribution of the radiation transmitted through the subject has been widely in use. These days, a radiation image generating system using an FPD (Flat Panel Detector) that detects a radiation and converts the detected radiation into electricity energy to be detected as radiation image information is being proposed upon radiography. In addition, a cassette-type FDP has also been developed for the purpose of improving the transportability and handling ability of the FPD (for example, see JP-Tokukaihei-6-342099A).

However, in the radiation image generating system as described above, since the FPD of the conventional type is connected with a cable all the time, it is troublesome when replacing and transporting the FPD. Furthermore, such a cable and the like are also troublesome when setting the FPD, having caused a problem of inconvenience in the preparation works for the image generation. Therefore, it has been proposed to provide a transmission unit for transmitting image signals to the exterior apparatuses in the cassette-type FPD and to send radiation image information detected by the FPD to an image processing apparatus in a wireless mode in order to improve the degree of freedom in the configuration of the radiation image generating system (for example, see JP-Tokukaihei-7-140255A).

It has been further proposed to provide a cassette-type FPD with a connector connectable with a wireless module and a cable for communicating with a system control unit to thereby detect and then display if the communication is established through the connection with the wireless module or the cable, or not through the connection with the both (for example, see JP-Tokukai-2004-173907A).

However, if it is configured such that the radiation image information detected by the FPD is transmitted to an image processing apparatus in a wireless mode, electromagnetic waves are generated at the time of transmitting the radiation image information. Since such electromagnetic waves are possibly causing malfunction of a medical device such as a pacemaker, it could be dangerous for the lives and bodies of patients who are wearing a medical device such as a pacemaker in their bodies, when the above-described apparatuses are used in a wireless mode. Because of that, there is a problem that the radiation image generating system by which radiation image information is transmitted in a wireless mode cannot be used for the case of generating images of patients having worn a medical device such as a pacemaker in their bodies.

Furthermore, the transmission of the radiation image information in a wireless mode has such an additional disadvantage that the transmission of the radiation image information is possibly disabled, for example, when any communication disturbance such as obstacles and other influential electric waves is generated. In this case, it is problematic because the subsequent image generation cannot be performed until the communication state is recovered.

### SUMMARY OF THE INVENTION

The present invention has been achieved to solve the above-described problems, and it is an object of the present invention to provide a radiation image detector and a radiation image generating system, which can maintain the degree of freedom in the system configuration, generate a radiation image safely for a patient who is wearing a medical device such as a pacemaker, and immediately take a countermeasure with another means even when any trouble has been caused in one of the means for transmitting radiation image information.

To achieve the above object, in accordance with the first aspect of the present invention, the radiation image detector comprises:
a radiation image obtaining section to detect radiation irradiated and obtain a radiation image data;
a communication unit to transmit the radiation image data to an external apparatus;
a storing section attachment part which is capable of removably holding a storing section for storing the radiation image data, and causes the attached storing section to preserve the radiation image data obtained by the radiation image obtaining section; and
a control unit that to select whether to transmit the radiation image data from the communication unit or to transmit the radiation image data by using the storing section,
wherein the control unit changes over a transmission mode for transmitting the radiation image data to the external apparatus based on a result of the selection.

According to the first aspect of the present invention, the radiation image detector has two transmission modes for transmitting a radiation image data to the external apparatus, in one of which the transmission is performed by the communication unit, and in the other of which the transmission is performed by the storing section for storing a radiation image data that is removably attached, and the control unit can select the mode of transmitting by the communication unit or the mode of transmitting by the storing section for the transmitting a radiation image data and change over from one to another, so that the degree of freedom in the system configuration can be increased.

For example, when the mode of transmitting by the communication section is employed, the transmission can be performed in either a wireless mode or a wired mode. In a case of the wireless transmission mode is used, the portability of the radiation image detector can be improved and the handling thereof will be facilitated. Selection of the transmission mode where a radiation image data is transmitted by removing the storing section from the radiation image detector and then attaching it to the external apparatus may permit to safely generate images of a patient who is wearing a medical device such as a pacemaker, because no harmful electromagnetic waves will be generated in this mode.

Because the radiation image detector has the plurality of selectable transmission modes, the degree of freedom in the system configuration is increased, a transmission mode corresponding to the need of an individual patient can be easily selected to ensure safeness for the patient, and it is possible to immediately take a countermeasure with the other means even when any malfunction is caused in one of the plurality of transmission modes, thus enabling an operator to promptly continue to generate radiation images.

In particular, when the radiation image detector is used in a place where a communication environment is not established well, for example, in a case of physical examinations held in a public hall or in a case of a disaster, it is possible to use the storing section to transmit radiation images to the external apparatus. Further, when the radiation image detector is used in an environment where the image generation is executed frequently, for example in an X-ray image generating room, improvement in the productivity for the image generation can also be achieved because radiation image data can be transmitted via communication in an immediate and smooth manner. As described above, the radiation image detector can correspond to various use environments because it has the plurality of selectable transmission modes.

Preferably, the communication unit performs communication in a wireless mode.

Therefore, transportability of the radiation image detector can be facilitated because there is no need to connect a cable and the like to the radiation image detector, and operation of the radiation image detector can also be facilitated because cables are not tangled. Moreover, the degree of freedom in the system configuration can be increased because, for example, the operation to prepare for the image generation can be made smoothly because of no obstacles at the time of setting the radiation image detector.

Preferably, the wireless mode uses microwave or light.

Therefore, a radiation image data with a large capacity can be transmitted effectively at high speed, thereby the efficiency of image generation can be improved in total.

Preferably, the radiation image detector comprises a connecting terminal to be connected directly or indirectly to the external apparatus and connected with a cable for transmitting the radiation image data.

The radiation image detector is connected with the external apparatus in a wired mode via the cable to be attached to the connecting terminal to transmit a radiation image data. As a result, an advantageous effect that allows to safely generate images of a patient who is wearing a medical device such as a pacemaker can be attained. Further, in a case of employing the wired mode using the cable, it is possible to rapidly transmit mass information being greater than that by means of a wireless mode and to take a reaction simply and immediately when it is desired to promptly display image-generated results on the external apparatus or to transmit a moving image and a plurality of images.

Preferably, the radiation image detector comprises a connecting terminal to be connected directly or indirectly to the external apparatus and connected with a cradle for transmitting the radiation image data.

Since it is possible to transmit a radiation image data to the external apparatus by attaching the radiation image detector to the cradle, the radiation image can be transmitted with simple operations.

Preferably, when the cable or the cradle is attached to the connecting terminal, the control unit causes to transmit the radiation image data from the connecting terminal.

Since the transmission mode for transmitting a radiation image data of the radiation image detector is switched to a wired mode via the cable or the cradle by attaching the cable or the cradle to the connecting terminal of the radiation image detector, it is possible to change over the transmission mode to the wired mode in a simple and firm manner, allowing to safely generate an image of a patient who is wearing a medical device such as a pacemaker. Further, even when any malfunction was caused in the transmission in the wireless mode, the transmission mode can be changed over to the wired mode immediately so that the image generation can be continued in a prompt manner.

Preferably, a change-over switch for changing over a transmission mode between at least a mode to transmit from the communication unit and a mode to transmit by the storing section is provided, and the control unit causes to transmit the radiation image data from either the communication unit or the storing section in response to the changing-over of the change-over switch.

Therefore, it is possible to change over the transmission mode for transmitting a radiation image data among a plurality of transmission modes by changing over the switch provided on the radiation image detector. As a result, it is possible to select a wireless mode to increase the degree of freedom in the system configuration, or, it is possible to change over the transmission mode to the mode in which a radiation image data is transmitted through the storing section that has been removed from the radiation image detector and then attached to the external apparatus and with which no harmful electromagnetic waves are generated to safely generate an image of a patient who is wearing a medical device such as a pacemaker. Since the radiation image detector has a plurality of transmission modes, it can easily select a transmission mode corresponding to the needs for respective patients to ensure safeness for the patient as described above, and can change over a transmission mode to the other mode immediately even when any malfunction was caused in the transmission mode having been used, so that image generation operation can be performed continuously in a prompt manner.

Preferably, when a signal for changing over a transmission mode for transmitting a radiation image data between a mode to transmit from the communication unit and a mode to transmit by the storing section was sent from the external apparatus, the control unit causes to transmit the radiation image data from the communication unit or the storing section in accordance with the signal.

Since the radiation image detector can change over a transmission mode for transmitting a radiation image data among a plurality of transmission modes in accordance with the signal sent from the external apparatus, it is possible to select a wireless mode to increase the degree of freedom in the system configuration, or it is possible to change over the transmission mode to the mode in which a radiation image data is transmitted through the storing section that has been removed from the radiation image detector and then attached to the external apparatus and with which no harmful electromagnetic waves are generated to safely generate an image of a patient who is wearing a medical device such as a pacemaker. Since the radiation image detector has a plurality of transmission modes, it can easily select a transmission mode corresponding to the needs for respective patients to ensure safeness for the patient as described above and can further change over the transmission mode to the other mode immediately even when any malfunction was caused in the transmission mode having been used, so that the image generation operation can be performed continuously in a prompt manner.

Preferably, the radiation image detector comprises an image memory to store the radiation image data.

Since the radiation image detector can temporarily store a detected radiation image data in the image memory, the radiation image detector is not required to immediately transmit the detected radiation image data to the external apparatus. As a result, the radiation image detector is not required to be connected with a cable for transmitting a radiation image data to the external apparatus all the time, thereby the degree of freedom in handling the radiation image detector is increased. Still further, since the radiation image detector is not required to immediately transmit the detected radiation image data to the external apparatus after the image data of the radiation image was detected, the radiation image detector can be operated so as to transmit radiation image data having been accumulated in the image memory in the mass after carrying out plural times of image generation operations. Even when the transmission of radiation image data has failed due to any malfunction, it is possible to transmit once more by using the other transmission section because the radiation image data has been stored in the image memory.

Preferably, the radiation image detector includes a flat panel detector (FPD) to detect radiation which was irradiated and to convert the radiation into an electric signal to obtain the radiation image data.

Since the radiation image detector includes the FPD, it can promptly read a radiation image and employ a transmission mode in which, for example, the storing section is removed from the radiation image detector and then attached to the external apparatus to thereby transmit a radiation image data as well as a wireless transmission mode. Accordingly, it is easy to transport and handle the radiation image detector, and the degree of freedom in the system configuration can be increased.

Preferably, the radiation image detector comprises an internal electrical power source to supply electric power to at least the radiation image obtaining section and the control unit.

Since electric power is supplied from the internal electrical power source to the radiation image obtaining section and the control unit both being necessary for obtaining a radiation image data, the radiation image detector can generate an image without being connected with a cable and the like and is easy to be handled, thereby improving the degree of freedom in the system configuration.

In accordance with the second aspect of the present invention, the radiation image generating system comprises:
the radiation image detector having
a radiation image obtaining section to detect radiation irradiated and obtain a radiation image data,
a communication unit to transmit the radiation image data to an external apparatus,
a storing section attachment part which is capable of removably holding a storing section for storing the radiation image data, and causes the attached storing section to preserve the radiation image data obtained by the radiation image obtaining section, and
a control unit that to select whether to transmit the radiation image data from the communication unit or to transmit the radiation image data by using the storing section,
wherein the control unit changes over a transmission mode for transmitting the radiation image data to the external apparatus based on a result of the selection; and
a console to operate the radiation image detector,
wherein the console comprises a communication unit to communicate with the external apparatus, and receives a radiation image data when the console was connected with either the communication unit provided in the radiation image detector or the storing section removably held by the storing section attachment part.

As above, the radiation image generating system has a plurality of transmission modes for transmitting a detected radiation image data, and the radiation image data is transmitted to the console by means of a transmission mode which was properly selected from the radiation image detector that can change over the transmission mode on proper occasions. Therefore, it is possible to select a wireless transmission mode to increase the degree of freedom in the system configuration, or it is possible to change over the transmission mode to the mode in which a radiation image data is transmitted through the storing section that has been removed from the radiation image detector and then attached to the external apparatus and with which no harmful electromagnetic waves are generated to safely generate an image of a patient who is wearing a medical device such as a pacemaker. Since the radiation image detector has a plurality of transmission modes, it can easily select a transmission mode corresponding to the needs for respective patients to ensure safeness for the patient as described above and can further change over the transmission mode to the other mode immediately even when any malfunction was caused in the transmission mode having been used, so that the image generation operation can be performed continuously in a prompt manner.

Preferably, the radiation image generating system comprises a radio relaying apparatus to relay a radio signal to be transmitted and received between the communication unit in the radiation image detector and the communication unit in the console.

Since the radiation image generating system performs a wireless communication via the radio relaying apparatus, it is no need to directly radio-communicate from the radiation image detector to the console that is installed in many cases in a room separated from the radiation image detector, thereby a radiation image data with a large capacity can be transmitted effectively at high speed and the image generation efficiency in total can be further improved.

Preferably, the radiation image generating system comprises a plurality of image generating rooms, in each of which the radiation image detector and the radio relaying apparatus are disposed, and a plurality of radio relaying apparatuses and a plurality of consoles in the plurality of image generating rooms are connected one another through a network.

Since the wireless communication is performed via the radio relaying apparatus, a radiation image data with a large capacity can be transmitted effectively at high speed and the image generation efficiency in total can be further improved even when the radiation image detector is displaced to the other image generating room.

### BRIEF DEACRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a schematic configuration view illustrating the first embodiment of a radiation image generating system to which the present invention is applied;

FIG. 2 is a block diagram showing the main portion of a radiation image detector constituting the radiation image generating system shown in FIG. 1;

FIG. 3 is a perspective view illustrating the schematic configuration of the radiation image detector shown in FIG. 2;

FIG. 4 is a block diagram showing the main portion of a console constituting the radiation image generating system shown in FIG. 1;

FIG. 5 is a flow chart for explaining a process to select a transmission mode for transmitting radiation image information in the first embodiment;

FIG. 6 is a perspective view illustrating the schematic configuration of the modified example for the radiation image detector according to the first embodiment;

FIG. 7 is a block diagram showing the main configuration of a radiation image detector constituting the radiation image generating system according to the second embodiment;

FIG. 8 is a block diagram showing the main configuration of a radiation image detector constituting the radiation image generating system according to the third embodiment; and

FIG. 9 is a view illustrating the schematic configuration of the fourth embodiment for the radiation image generating system to which the present invention is applied.

### DETAILED DESCRIPTION OF THE PREFERRED EMBODIMENTS

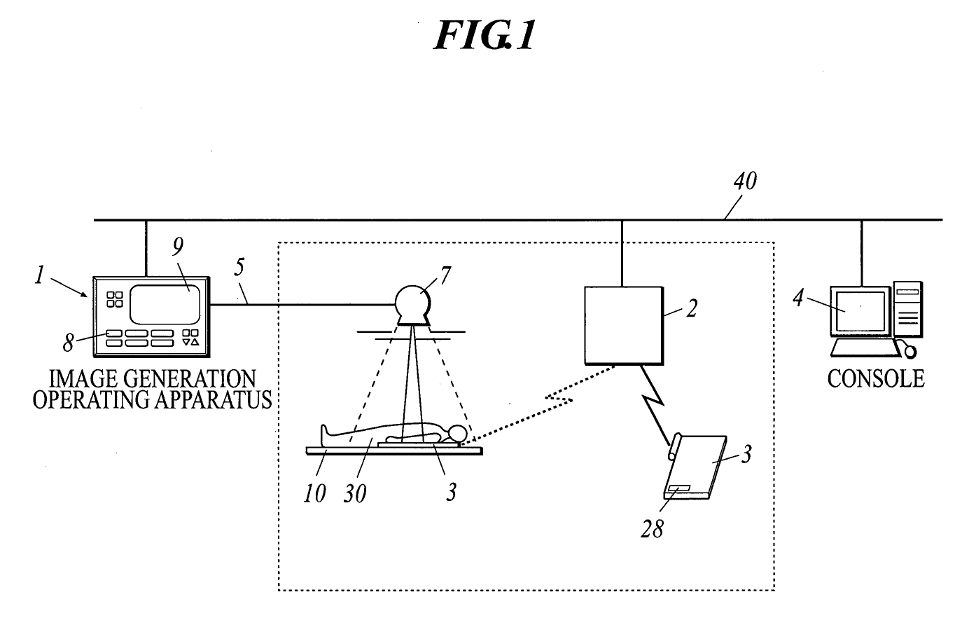

The first embodiment for the radiation image detector and the radiation image generating system according to the present invention is explained below referring FIGS. 1 to 5.

FIG. 1 is a schematic configuration view illustrating the first embodiment for the radiation image generating system to which the radiation image detector according to the present invention is applied.

According to the first embodiment, as shown in FIG. 1, an image generation operating apparatus 1 for performing operations related to radiation image generation, a base station 2 for performing communications with employing a wireless communication mode such as a wireless LAN (Local Area Network) and a console 4 for operating a radiation image detector 3 that reads radiation having been irradiated against a patient 30 to be an image generation subject to detect a radiation image and for image-processing the radiation image detected by the radiation image detector are connected one another via a network 40 in the radiation image generating system. To the image generation operating apparatus 1, a radiation source 7 for irradiating radiation against the patient 30 to perform image generation of a radiation image is connected via a cable 5. In this connection, the network 40 may be a communication line dedicated for the system of the present invention. However, for reason of that the degree of freedom in the system configuration in a case of the dedicated line is made lowered, it is preferable that the network is one of the existing lines, such as Ethernet (trade name). To the network 40, a server (not shown) for controlling information related to the radiation image generation, such as information on the patient 30 and the like and image generation conditions, is further connected.

The image generation operating apparatus 1 comprises an operating panel provided with an input operation unit 8 for inputting an instruction made by a user, a display unit 9 for displaying values and the like having been input and the like, and a power source (not shown) for supplying electricity to the radiation source 7. When the user operates the image generation operating apparatus 1, a tube voltage is applied to the radiation source 7, and at the same time, a tube current is turned on, thereby radiation is irradiated against the patient 30.

A cradle 10 for loading the patient 30 is placed within the radiation irradiating range beneath the radiation source 7, and the radiation image detector 3 for reading radiation to thereby detect a radiation image is located at a position on the cradle 10 that is corresponding to the image generating portion of the patient 30 lying on the cradle. Note that the positioning of the radiation image detector 3 is not limited to a point between the patient 30 and the cradle 10. For example, a detector attachment opening (not shown) for attaching the radiation image detector 3 may be provided beneath the cradle 10 so that the radiation image detector 3 is attached into the detection attachment opening.

Now, the radiation image detector 3 to be applied in the above-described first embodiment will be explained in the following.

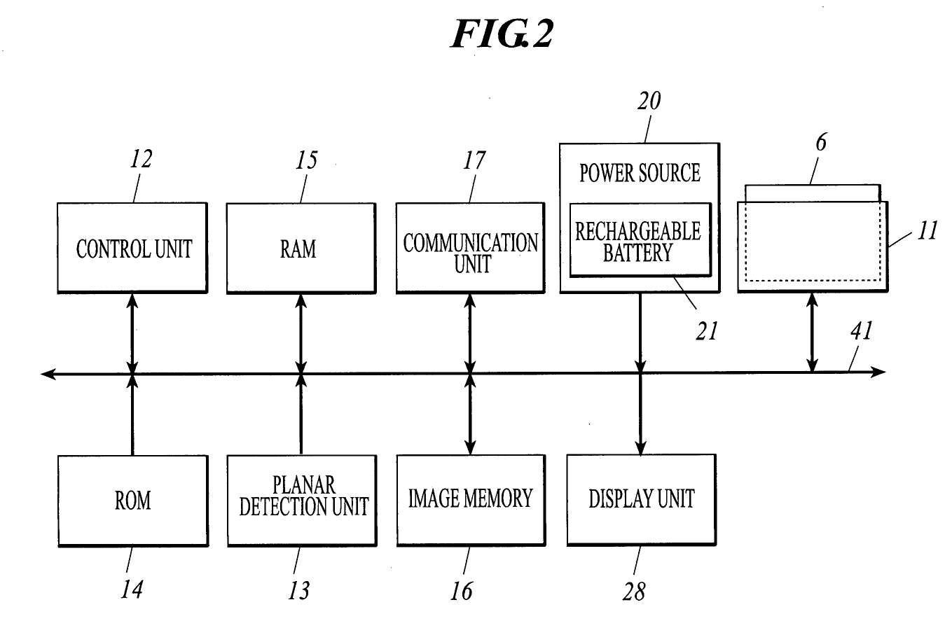

FIG. 2 is a block diagram showing the schematic configuration of the radiation image detector 3. The radiation image detector 3 is, for example a cassette-type flat panel detector (FPD), and includes a control unit 12 for controlling the respective components and a planar detection unit 13 acting as a radiation image obtaining section for detecting radiation to obtain a radiation image data.

The control unit 12 comprises, for example, a CPU (Central Processing Unit) or the like, which reads out a predetermined program being stored in a ROM 14, develops the program in the work area of a RAM 15, and executes various processings in accordance with the program. Various information on the image generation, operator's IDs and the like are sent to the control unit 12 via the network 40. The control unit 12 links the above-described information with the obtained image data and transmits them to the console 4.

The planar detection unit 13 is consisted of a plurality of pixels being arrayed in the matrix state on a predetermined substrate, e.g. a glass substrate, which detects radiation irradiated from the radiation irradiating apparatus and having passed through at least the patient 30 as an image generation subject according to its intensity, and converts the detected radiation into the electric signals.

Here, the planar detection unit 13, though an illustration of which being omitted, includes the indirect type which has, for example, a radiation-to-light conversion layer for converting radiation into fluorescent light and a light-to-electricity conversion layer for detecting the fluorescent light converted by the radiation-to-light conversion layer and then converting the fluorescent light into the electric signals, and the direct type which has a radiation-to-charge conversion layer having a radiation receiving section that directly converts radiation into charges instead of the radiation-to-light conversion layer and the light-to-electricity conversion layer, and so on.

The radiation image detector 3 contains an image memory 16 that temporarily stores radiation image information detected by the planar detection unit 13. The image memory 16 is consisted of, for example, a nonvolatile memory such as a flash memory and stores an image data that is information on the radiation image which was detected and converted into the electric signals by the planar detection unit 13.

Further, as shown in FIG. 2, the radiation image detector 3 holds an attachable/removable memory 6 as a storing unit for storing the radiation image information detected by the planar detection unit 13 separately from the image memory 16, and contains a storing section attachment part 11 for causing the attachable/removable memory 6 to preserve the radiation image information detected by the planar detection unit 13.

For the attachable/removable memory 6, various memory card including, for example, SD memory card (trade name), memory stick (trade name), smart media (trade name) and compact flash (trade name) are applicable, and any standard thereof may be acceptable. Further, the attachable/removable memory 6 is not limited to a memory card and may be any of various portable-type storing media, such as an FD, a MO, a CD-R and a DVD-R. In addition, the memory may be a storing medium having a USB terminal, which may store the radiation image information by directly attaching the terminal to an attachment section adapted for USB. The storing section attachment part 11 is configured to fit to an attachable/removable memory 6 to be applied and may be configured, for example, such that it can fit to plural types of attachable/removable memories.

The image memory 16 may be a memory either with a small capacity as much as it can store one image or with a larger capacity capable of storing a plurality of images. If the image memory has a larger capacity, it will be needless to send radiation image information every time at generating an image and plural times of the image generations can be performed in series.

The radiation image data detected by the planar detection unit 13 may be stored in the image memory 16 or in the attachable/removable memory 6. Also, the radiation image data may be stored in both of the image memory 16 and the attachable/removable memory 6.

The radiation image detector 3 is provided with a communication unit 17 for transmitting image data to be used for a transmission mode to transmit image data being a radiation image information converted into electric signals to the console 4 as an exterior apparatus. The communication unit 17 performs communications of various information with the console 4 in a wireless communication mode, such as the wireless LAN, via the base station 2, that is a radio relaying apparatus for relaying radio signals. The base station 2 is placed in an image generating room in which the radiation image detector 3 having been installed, and the base station 2 and the console 4 are connected to each other by means of, for example, a cable (not shown) or the like.

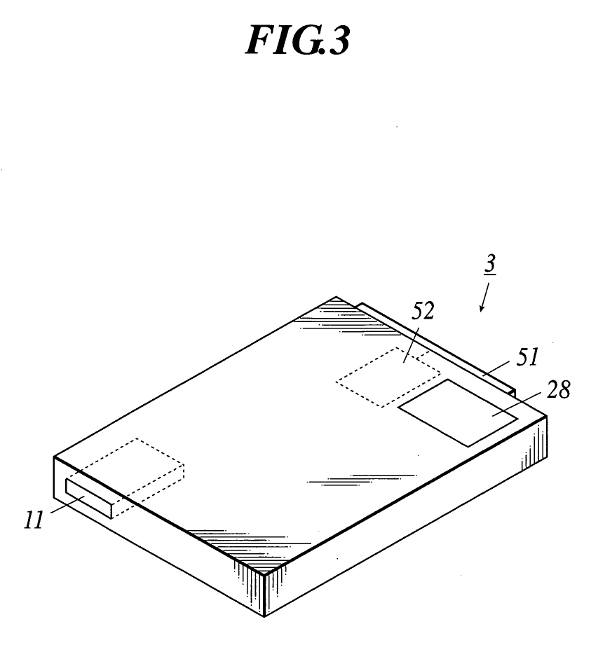

The communication unit 17 comprises an antenna 51 (see FIG. 3) for transmitting/receiving various signals to/from the communication unit 25 of the console 4 and a wireless circuit 52 (see FIG. 3) for demodulating the received signal which was input to the antenna 51, and for modulating/amplifying various signals and outputting the signals to the antenna 51.

As shown in FIG. 3, the antenna 51 is installed in an outer end of the radiation image detector 3. The wireless circuit 52 to which the antenna 51 is connected is installed inside the radiation image detector 3. In response to the driving of the wireless circuit 52, the antenna 51 starts to transmit/receive electromagnetic waves. The frequencies to be applied to the antenna 51 and the wireless circuit 52 are not particularly limited. However, it is preferable to apply microwaves with a frequency of from 30 MHz to 300 GHz, preferably 1 GHz to 200 GHz, with which image data having a large capacity can be transmitted/received at high speed. It should be noted that the shape and disposal of the antenna 51 is not limited to those shown in FIG. 1.

In this embodiment, the radiation image detector 3 contains a communication detection section (not shown) for detecting whether the communication unit 17 can normally communicate with the console 4 or not. The result of the detection made by the communication detection section is sent to the control unit 12. Following thereto, the control unit 12 selects depending on the detection result either to transmit the radiation image information from the communication unit 17 or to transmit it by means of the attachable/removable memory 6. Further, the control unit 12 is adapted to change over the transmission mode to transmit the radiation image information to the console 4.

When the image data was normally sent to the console 4, an electric signal is sent from the console 4 to the control unit 12 located at the side of the radiation image detector 3. When the control unit 12 received the signal from the console 4, the control unit 12 deletes the image data having been transmitted among the image data stored in the image memory 16 or the attachable/removable memory 6. Note that the image data may be transmitted at every image generation to the console 4, and the image data having been transmitted among the image data stored in the image memory 16 may be deleted in turn. Alternatively, the image data may be transmitted to the console 4 at every occasion where the image generation was completed for one patient 30 or where a predetermined times of image generation was completed, and the image data having been transmitted among the image data stored in the image memory 16 or the attachable/removable memory 6 may be deleted in turn.

Furthermore, the radiation image detector 3 is provided with a power source 20 as an internal electrical power source for supplying electric power to the respective components. The power source 20 contains a rechargeable battery 21 for supplying electric power to the respective components constituting the radiation image detector 3 and is structured to be connected to an external electrical power source to be charged. Examples applicable as the rechargeable battery 21 includes chargeable batteries, for example, a nickel-cadmium battery, a nickel-hydrogen battery, a lithium ion battery a compact-sealed lead acid battery, a lead storage battery, a fuel battery, a solar battery and the like. With the rechargeable battery 21, it is made possible to continuously operate the image generations even when the radiation image detector 3 is not connected all the time to an external electrical power source (not shown) by means of a cable or the like. The rechargeable battery 21 may be the type being chargeable while it is attached to the radiation image detector 3 or the type required to be removed from the radiation image detector 3 to perform charging thereof.

Further, a display unit 28 for displaying the communication state of the communication unit 17, the charging state in the rechargeable battery 21, the state of the various operations and the like is provided at an end portion in the surface of the radiation image detector 3 so that the operators can check the communication state of the communication unit 17, the charging state in the rechargeable battery 21 of the radiation image detector 3 and the like with their naked eyes.

The control unit 12, the planar detection unit 13, the image memory 16, the storing section attachment part 11, the communication unit 17, the RAM 15, the ROM 14, the power source 20 and the display unit 28 are connected one another by means of a bus 41.

Now, the console 4 to be applied to this embodiment will be explained in the following.

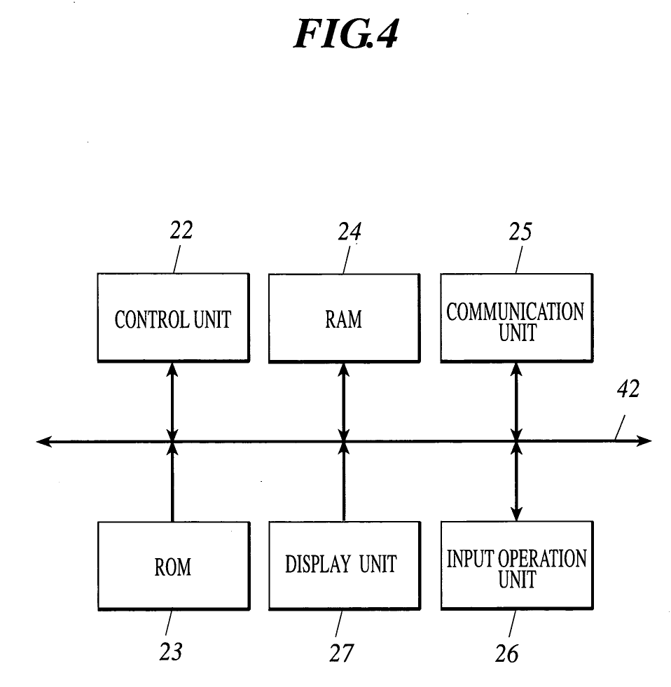

FIG. 4 is a block diagram showing the schematic configuration of the console 4. The console 4 as an external apparatus to be connected with the radiation image detector 3 is consisted of a computer and contains a control unit 22 for controlling the respective units. The control unit 22 is consisted of, for example, a CPU (Central Processing Unit) or the like and reads out a predetermined program stored in a ROM 23, develops the program to the operational region of a RAM 24, and subsequently executes various processings in accordance with the program.

The console 4 is provided also with the communication unit 25 for performing transmission/reception of information between itself and an external apparatus such as the radiation image detector 3, wherein the communication unit 25 receives image data sent from the radiation image detector. When the control unit 22 has received the image data normally, the control unit 22 transmits an electric signal indicating the normal reception of the image data from the communication unit 25 to the control unit 22 locating at the radiation image detector 3 side.

The console 4 includes an input operation unit 26 for inputting instructions and the like with respect to reading of image data and transmission/reception of image data. The input operation unit 26 comprises, for example, an operation panel, a mouse, a keyboard and the like, and outputs an operation signal generated by the operation panel or the mouse and a pushing-down signal generated by the keyboard in the form of an input signal to the control unit 22. In particular, in the radiation image generating system according to this embodiment, the input operation unit 26 outputs a signal relating to an instruction for transmitting radiation image data having been detected by the radiation image detector 3 based on a predetermined operational procedure to the control unit 22 locating at the radiation image detector 3 side. Note that information on a patient and the image generation and the other information may be input from the input operation unit 26, instead of obtaining from a server.

Specifically, a user can operate the input operation unit 26 to select whether an image data should be transmitted from the radiation image detector 3 in a wireless mode or in a wired mode, and whether image data should be transmitted at every occasion where one radiation image generation has been completed or image data should be transmitted in the mass at every occasion where a predetermined times of radiation image generations have been completed.

The configuration of the input operation unit 26 is not limited to that described hereinabove, if the input operation unit 26 can set various processing conditions. Also, the instructions and information to be input from the input operation unit 26 are not limited to those described above.

The console 4 is also provided with a display unit 27 which displays the information input from the input operation unit 26 and the image data sent from the radiation image detector 3. The items to be displayed on the display unit 27 are not limited to those described above, and for example, a thumbnail image of the obtained image data may be displayed on the display unit 27. The display unit 27 is configured by including, for example, a CRT (Cathode Ray Tube) and an LCD (Liquid Crystal Display), and displays various screens in accordance with an instruction of an input display signal which was output from the control unit 22.

The control unit 22 controls the radiation image detector 3 to cause it to forward the image data in accordance with an instruction input from the input operation unit 26. The forwarded image data is further forwarded to a server, and various image processings, such as the normalizing and gradating processings, are carried out in the server. Note that various image processings for the received image data may be carried out in the control unit 22 in the console 4.

The respective components, such as the control unit 22, the ROM 23, the RAM 24, the communication unit 25 and the input operation unit 26, are connected one another through a bus 42.

Now, the image generation processing for a radiation image in the radiation image generating system to which the radiation image detector 3 according to the present invention is applied will be explained in the following.

When the radiation image generation is performed, information on a patient and information on a radiation image are transmitted from the server, the respective reading apparatus for various information such as an ID card reader, or the other PC (personal computer) being connected to the network 40 and installed in a medical examination room and the like. Such information are displayed on the display unit 27 in the console 4, and a user operates the image generation operating apparatus 1 while checking those information, then performing an irradiation of radiation in a predetermined dose from the radiation source 7 to the patient 30. Note that the patient information and the image generation information may be displayed on the display unit 9 in the image generation operating apparatus 1 instead of the display unit 27 in the console 4.

At this occasion, the radiation image detector 3 is disposed between the cradle 10 and the patient 30, and detects the dose of radiation penetrating the patient 30 and converts the detected radiation into an electric signal to obtain an image data. The image data obtained by the radiation image detector 3 is temporarily stored in either the image memory 16 or the attachable/removable memory 6.

When the image data is obtained by the radiation image detector 3, the control unit 12 makes a selection of a transmission mode for the obtained image data from two modes consisted of a wireless mode transmitting from the communication unit 17 via the base station 2 or the other mode wherein the attachable/removable memory 6 is removed from the radiation image detector 3 and then attached directly to the console 4.

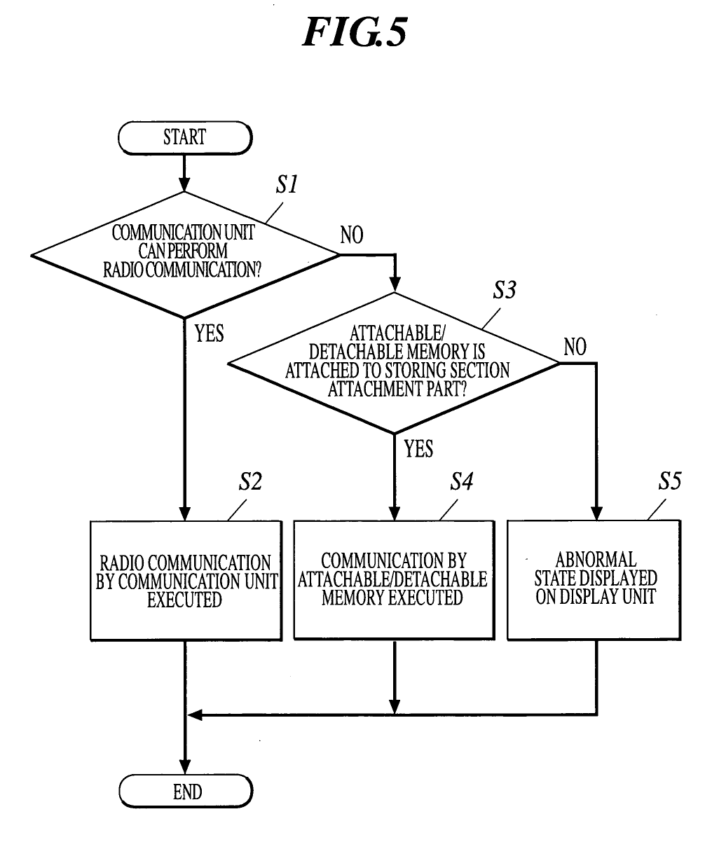

Now, a procedure of the processing to select the transmission mode described above will be explained with referring to FIG. 5. First, the communication detection section detects whether the communication unit 17 is in a state being capable of normally communicating with the console 4, and the detection result is sent to the control unit 12. The control unit 12 determines on the basis of the detection result having been sent whether the communication unit 17 can normally perform a wireless communication or not (Step S1). When the communication unit 17 can perform a wireless communication (Step 1; YES), the control unit 12 selects a transmission mode where an image data is transmitted from the communication unit 17 in a wireless mode (Step S2). On the other hand, an attachment detection section detects whether the attachable/removable memory has been attached to the storing section attachment part 11 or not, and the result of the detection is sent to the control unit 12. If the control unit 12 has determined that the communication cannot be performed from the communication unit 17 (Step S1; NO), the control unit 12 further determines whether the attachable/removable memory 6 has been attached to the storing section attachment part 11 or not on the basis of the detected result sent from the attachment detection section (Step S3). When it is determined by the detected result made by the attachment detection section that the attachable/removable memory 6 has been attached to the storing section attachment part 11 (Step S3; YES), the control unit 12 selects the transmission mode in which a transmission is performed by removing the attachable/removable memory 6 from the radiation image detector 3 and then attaching it directly to the console 4 (Step S4). Note that, when the control unit 12 selected to transmit an image data by means of the attachable/removable memory 6, the selection may be displayed on the display unit 28. On the other hand, when it has been determined with the detected result made by the attachment detection section that the attachable/removable memory 6 has not been attached to the storing section attachment part 11 (Step S3; NO), the control unit 12 causes the display unit 28 to display indicating that an image data can be transmitted neither by the communication unit 17 nor the attachable/removable memory 6 so that a user can notice it. (Step S5).

It may be configured beforehand such that, while an image generation has been performed and an image data is obtained by the radiation image detector 3, the image data is transmitted in a wireless mode from the communication unit 17 to the console 4. In this case, if the transmission from the communication unit 17 failed, the control unit 12 selects the transmission by means of the attachable/removable memory 6. In the case where the image data is obtained and transmitted from the communication unit 17 at the same time as described above as well, it is preferable that the image data is temporarily stored in the image memory 16 or the attachable/removable memory 6 during the time until the transmission of the image data obtained by the radiation image detector 3 to the console 4 is completed. It may also be configured such that the image data is transmitted to the console 4 occasionally without storing it in the image memory 16 or the attachable/removable memory 6 when the image data is transmitted in a wireless mode.

If the console 4 has normally received the image data from the radiation image detector 3, it transmits a signal indicating the reception of the image data to the radiation image detector 3. Upon receipt of the signal from the console 4, the control unit 12 locating at the radiation image detector 3 side deletes the image data corresponding to the signal from the console 4 out of the image data stored in the image memory 16 or the attachable/removable memory 6. The control unit 12 is adapted not to delete the image data stored in the image memory 16 or the attachable/removable memory 6 until the signal from the console 4 has been confirmed, and when the console 4 has not received the image data normally, it sends the information on the no reception to the radiation image detector 3. However, the control unit 12 may also be configured such that it does not delete the image data stored in the image memory 16 or the attachable/removable memory 6 for a while after the confirmation of the signal reception from the console 4. With this configuration, it is made possible to transmit the image data again in such cases that any abnormality in the transmitted image data being found later and that the image once transmitted was lost.

According to this embodiment, as described above, the radiation image generating system has the communication unit 17 and the storing section attachment part 11 which holds the attachable/removable memory 6 and causes the attachable/removable memory 6 to preserve the image data as the means for transmitting the image data detected by the radiation image detector 3, and the control unit 12 can select and change over the use of such component for transmitting the image data, so that it is possible to transmit the radiation image to the external device by means of either a wireless transmission mode or the transmission mode using the attachable/removable memory. As a result, the radiation image generating system according to this embodiment does not require a cable, can employ a wireless transmission mode with easy handling and can perform image generations safely even against a patient and the like who is wearing a medical device such as a pacemaker by changing over the transmission mode into the mode employing the attachable/removable memory 6 that causes no electromagnetic waves and the like. Furthermore, even when the radio communication is disabled due to communication disturbance or the like, the radiation image generating system can change over the transmission mode into the other mode to thereby transmit image data.

In addition, since microwaves are used when the transmission is carried out from the communication unit 17 in the wireless mode, an image data with a large capacity can be transmitted at high speed, thus enabling to meet the requirements in the medical field desiring to immediately check generated images.

Further, since the radiation image detector 3 includes the attachable/removable memory 6, it is possible to remove only the attachable/removable memory 6 and then attach it to the console 4 to thereby take out an image data simply and promptly and transmit the image data to the console 4.

Further, since the radiation image generating system is provided with the rechargeable battery 21 as an internal electrical power source for supplying electric power to at least the planar detection unit 13 and the control unit 12, it is possible to perform the image generation and the like in such a state that no cable is connected to the radiation image detector 3.

Note that, although the radiation image detector 3 is configured to include the attachable/removable memory 6 as a storing unit being removably installed in addition to the image memory 16 in this embodiment, the radiation image detector may be configured such that the image memory 16 serves as an attachable/removable storing unit as well and is removable from the radiation image detector 3.

In addition, although the radiation image generating system is configured so as to include an antenna 51 capable of transmitting microwaves as the antenna constituting the communicating section 17 in this embodiment, the radiation image generating system may be configured such that it includes a plurality of antennas. Further, other than the antenna 51 for performing transmissions with microwaves, an antenna for performing transmissions with rectilinear and less-directive electromagnetic waves having a frequency of 1 GHz or less (in particular 8×10² MHz or less, and further preferably 4×10² MHz or less) and a drive circuit for driving the later antenna may be installed in the radiation image generating system. In this case, the antenna 51 transmitting microwaves and the antenna transmitting electromagnetic waves having a frequency of 1 GHz or less may be configured to be driven by one circuit.

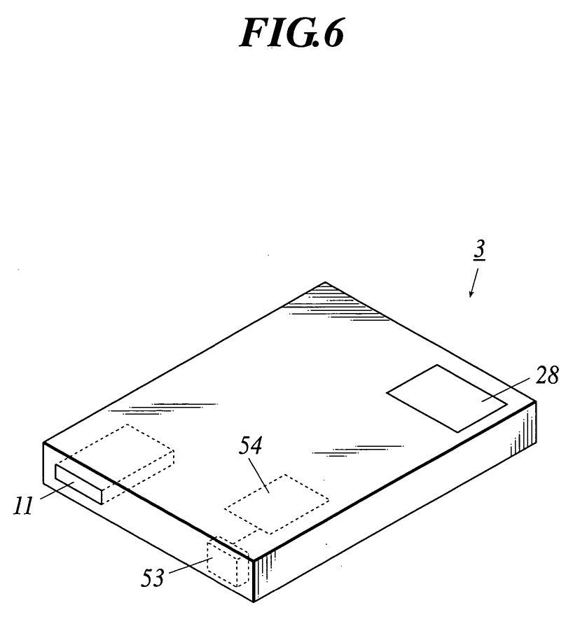

Further, although the communication unit 17 is configured so as to perform transmissions in a wireless mode by means of microwaves in this embodiment, it is not limited to microwaves as far as transmission is performed in a wireless mode. The communication unit may perform transmission by means of light in a wireless and non-contact mode. In this case, for example, an optical communication unit 53 for performing optical communication and an optical communication circuit 54 for operating the optical communication unit 53 are installed at one end inside the radiation image detector 3 as shown in FIG. 6. The optical communication unit 53 includes, for example, a light-emitting section (not shown) for emitting so-called infrared rays with a wavelength in a range of about 800 to 1000 nm. The optical communication circuit drives the light-emitting section to irradiate light such as infrared rays from the optical communication unit 53. By employing optical communication, a transmission of an image data with a large capacity at a high speed is made possible. The optical communication may be effected, other than infrared rays, by employing various lights including tera-waves, visible light and ultraviolet rays. When these lights are employed, an optical communication unit capable of irradiating those lights is required to be installed. Besides, in such a case that the communication unit 17 performs communications with use of light, a light reception section (not shown) for receiving light irradiated from the optical communication unit 53 is installed, and transmissions of image data is effected when light irradiated from the optical communication unit 53 is received by the light reception section.

Further, although the power source 20 as an internal electrical power source is configured so as to contain the rechargeable battery 21 in this embodiment, the electric power source is not limited to the source containing the rechargeable battery 21 and may be any power source with which at least the planar detection unit 13 and the control unit 12 can be driven without receiving electric power supply from the exterior. For example, the electric power source may be configured so as to contain an exchangeable disposal battery including manganese batteries, alkaline batteries, alkaline button cells, lithium batteries, silver oxide batteries, air zinc batteries, nickel-cadmium batteries, mercury batteries, lead batteries and the like instead of the rechargeable battery 21.

Further, although it is configured in this embodiment such that, when an image data can be transmitted by neither the communication unit 17 nor the attachable/removable memory 6, an indication informing the transmission-disabled state is displayed on the display unit 28 in the radiation image detector 3 so that a user is informed about the disabled state, the indication is not limited to the above example, and the indication may be any form with which a user can recognize such a state that an image data can be transmitted by neither the communication unit 17 nor the attachable/removable memory 6. For example, when the radiation image detector 3 is provided with an antenna separately from an antenna for transmitting an image data as described above, similarly to the case where the radiation image detector 3 is provided with an antenna for transmitting microwaves and an antenna for transmitting electromagnetic waves with a frequency of 1 GHz or less, and can transmit an image data by neither the communication unit 17 nor the attachable/removable memory 6, it may be configured such that the indication of the transmission-disabled state is transmitted to the external apparatus such as the console 4 and the indication is displayed on the display unit of the external apparatus such as the display unit 27 in the console 4, instead of causing the display unit 28 in the radiation image detector 3 to display the indication.

The present invention is not limited to the above-described embodiments and it is natural that the present invention may be modified beside the configurations described above.

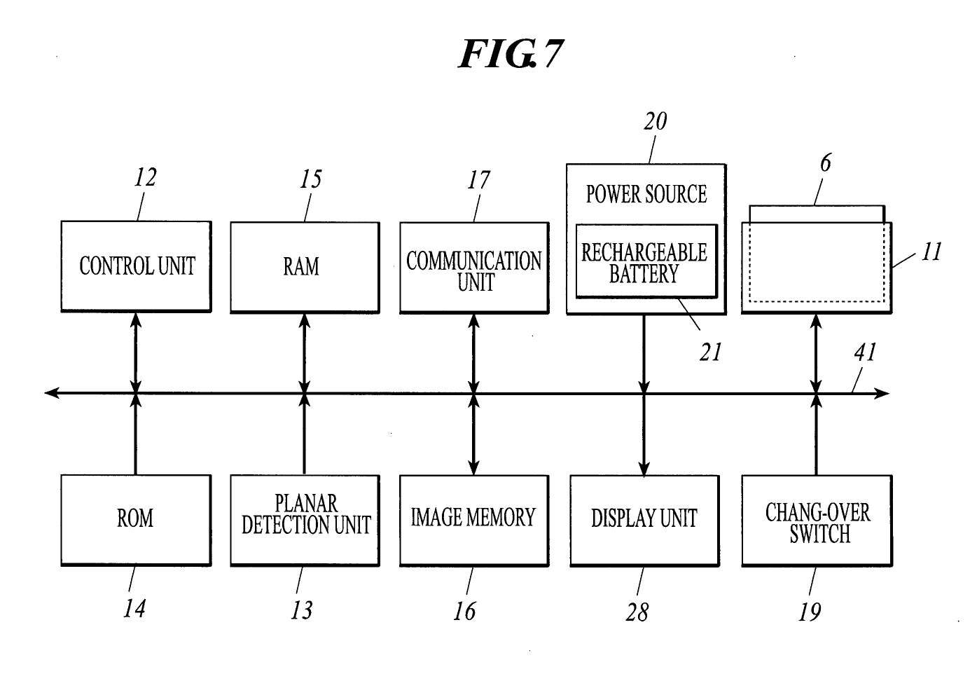

Now, the second embodiment for the radiation image detector and the radiation image generating system according to the present invention will be explained in the following with referring to FIG. 7. Note that, in the following description, only the aspects being different from the first embodiment will be described.

As shown in FIG. 7, in the second embodiment, the radiation image detector 3 is provided with a change-over switch 19 for changing over two transmission modes from one to another, in one of which an image data is transmitted from the communication unit 17 in a wireless mode, and in the other of which, for example, the attachable/removable memory 6 is removed from the radiation image detector 3 and then attached directly to the console 4 to thereby transmit an image data. The selection of the transmission mode for the image data is made by the control unit 12 based on the operational situation of the change-over switch 19 and the information sent from the console 4 side, and the control unit 12 is adapted to transmit the image data in the selected transmission mode to the console 4.

Since the other configurations are similarly to those described in the first embodiment, like reference signs are given to like parts to thereby omit explanations for those parts.

Now, radiation image generation operations with the radiation image generating system to which the radiation image detector 3 according to the present invention is applied will be described in the following.

When the radiation image detector 3 obtains an image data, the obtained image data is temporarily stored in either the image memory 16 or the attachable/removable memory 6.

Then, the transmission mode, that is a mode in which the image data obtained by the radiation image detector 3 is transmitted in a wireless mode from the console 4 or a mode in which the image data is transmitted in such a manner that the attachable/removable memory 6 is removed from the radiation image detector 3 and then attached directly to the console 4, is set in response to a user's operation to change over the change-over switch 19 being provided on the radiation image detector 3, and the control unit 12 selects the transmission mode set by the operation of the change-over switch as the transmission mode for transmitting the image data.

For example, for common image generations, the change-over switch is set in a wireless mode. In this case, the control unit 12 selects the wireless mode by means of the communication unit 17 as the transmission mode based on the signal sent from the change-over switch 19. Then, the control unit 12, while an image generation has been completed and the image data has been obtained by the radiation image detector 3, controls the communication unit 17 so that it transmits the image data in a wireless mode to the console 4. In this case as well, it is preferable that the image data obtained by the radiation image detector 3 is temporarily stored in either the image memory 16 or the attachable/removable memory 6 during the time in which the image data has been transmitted to the console 4. When the image data is transmitted in a wireless mode, the image data may be sent to the console 4 occasionally without storing the image data in either the image memory 16 or the attachable/removable memory 6. Then, when the patient 30 wearing a medical device such as a pacemaker is an image generation subject, or when a wireless transmission mode is not applicable due to communication disturbance or the like, a user operates the change-over switch 19 to set up the transmission mode into the mode using the attachable/removable memory 6. In this case, the control unit 12 selects the transmission mode to be operated by the attachable/removable memory 6 based on the signal sent from the change-over switch 19. Then, the attachable/removable memory 6 is removed from the radiation image detector 3 and then attached directly or indirectly to the console 4, thereby the image data having been stored in the attachable/removable memory 6 is transmitted to the console 4.

According to this embodiment, as described above, a user can arbitrarily set up by operating the change-over switch 19 an either mode of transmitting the image data detected by the radiation image detector 3 of transmitting in a wireless mode from the communication unit 17, or transmitting by the attachable/removable memory 6. Therefore, it is possible to select a wireless mode to thereby increase the degree of freedom in the system configuration and to safely generate images by changing over the transmission mode into a wired mode or the mode using the attachable/removable memory 6 that do not result in generating harmful electromagnetic waves when generating images of the patient 30 who is wearing a medical device such as a pacemaker. Furthermore, even when a situation where any transmission mode cannot be used has arisen, such as a case where a wireless transmission is disabled due to communication disturbance and the like, it is possible to perform a transmission of an image data by immediately changing over the transmission mode into the other mode.

In this embodiment, although it is configured such that the transmission mode of the image data can be set up by operating the change-over switch 19 on the radiation image detector 3, and the control unit 12 determines to transmit the image data according to the transmission mode having been set up, the configuration to set up the transmission mode of the image data is not limited to the example described hereinabove. For example, a transmission mode for the image data may be selected via an external apparatus, such as the input operation unit 26 and the like in the console 4, and the transmission mode for the image data may be set up upon reception of signals from such the external apparatus. In this case, the control unit selects the transmission mode having been set up according to the signals sent from the external apparatus as the transmission mode for transmitting the image data.

Note that, similarly to the first embodiment, the present invention is not limited to this embodiment.

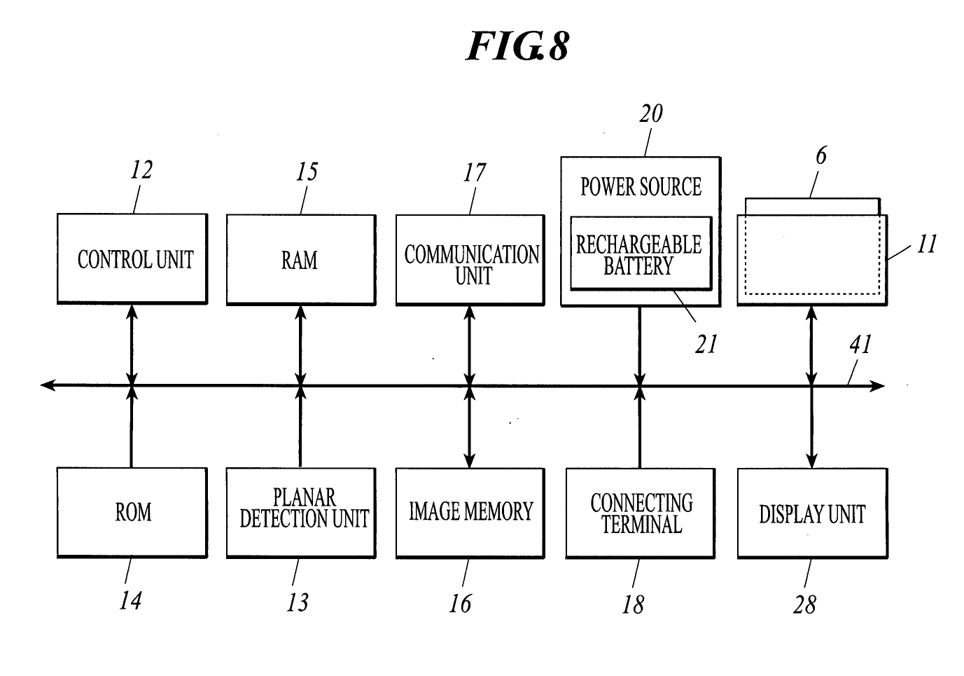

Now, the third embodiment for the radiation image detector and the radiation image generating system according to the present invention will be explained in the following with referring to FIG. 8. In the following, only particular aspects being different from the first and second embodiments are explained.

In this embodiment, as shown in FIG. 8, similarly to the first and second embodiments, the radiation image detector 3 comprises the storing section attachment part 11 which can removably hold the attachable/removable memory 6 and cause the attached attachable/removable memory 6 to preserve image data therein.

Further, the radiation image detector 3 contains the communication unit 17 and a connecting terminal 18 to be used for the transmission mode for transmitting image data to the console 4 as an external apparatus. The communication unit 17 performs communication of various information between itself and the console 4 via the base station 2 in a radio communication mode such as a wireless LAN, similarly to that in the first and second embodiments.

The connecting terminal 18 is attached to, for example, one outer end of the radiation image detector 3. The position to be attached and shape of the connecting terminal 18 are not limited particularly. The connecting terminal 18 is connectable with a cable (not shown) to be connected to the console 4. With the connection between the connecting terminal 18 and the console 4 through the cable, it is made possible to transmit the image data obtained by the planar detection unit 13 in a wired mode to the console 4.

Further, the radiation image detector 3 contains the control unit 12 similarly to those in the first and second embodiments. The control unit 12 make a selection of whether the transmission of an image data obtained by the planar detection unit 13 should be executed in a wireless mode from the communication unit 17 to the console 4, or through the connecting terminal, or by removing the attachable/removable memory 6 from the radiation image detector 3 and then attaching it directly to the console 4 or the like, and then controls the respective components to cause them to transmit the image data in the selected transmission mode to the console 4.

As a manner to determine and select the transmission mode for transmitting an image data, for example, the control unit 12 may be configured such that it transmits an image data in a wireless mode when nothing is connected to the connecting terminal 18, and selects a transmission mode so as to change over the transmission mode into a wired mode to thereby transmit image data when the connecting terminal 18 is connected with a cable, then controlling the respective components so that they transmit image data in the selected transmission mode to the console 4.

Since the other configurations are similarly to those described in the first and second embodiments, like reference signs are given to like parts to thereby omit explanations for those parts.

Now, radiation image generation operations with the radiation image generating system to which the radiation image detector 3 according to the present invention is applied will be described in the following.

When the radiation image detector 3 obtains an image data, the obtained image data is temporarily stored in either the image memory 16 or the attachable/removable memory 6.

Then, the control unit 12 selects a transmission mode for transmitting the image data obtained by the radiation image detector 3 whether it should be transmitted in a wireless mode from the communication unit 17 to the console 4, or transmitted in a wired mode through the connecting terminal 18, or by removing the attachable/removable memory 6 from the radiation image detector 3 and then attaching it directly to the console 4.

Specifically, the control unit 12 determines whether the communication unit 17 is in a normal condition to communicate with the console 4 or not. When it is determined that the communication unit 17 is in a condition capable of performing the communication, the control unit 12 selects a wireless mode through the communication unit 17 as the transmission mode and causes the communication unit 17 to transmit an image data. When it is determined that the communication unit 17 is in a communication-disabled condition, the control unit 12 further determines whether the attachable/removable memory 6 is attached to the storing section attachment part 11 or not. When it is determined that the attachable/removable memory 6 is attached, the control unit 12 selects the transmission mode in which the transmission is performed by removing the attachable/removable memory 6 from the radiation image detector 3 and then attaching it directly to the console 4. Further, when it is determined that the attachable/removable memory 6 is not attached, the control unit 12 determines whether the connecting terminal 18 is connected with a cable or not. When it is determined that a cable is connected to the connecting terminal 18, the control unit 12 selects a wired mode through the connecting terminal 18 as the transmission mode to thereby transmit an image data through the connecting terminal 18. When a cable is connected to the connecting terminal 18, the control unit 12 may be configured so as to select a wired mode through the connecting terminal 18 as the transmission mode to thereby transmit an image data through the connecting terminal 18 irrespective of the communication condition of the communication unit 17 and whether the attachable/removable memory 6 is attached to the storing section attachment part 11 or not.

According to this embodiment, as described above, the control unit 12 can selects a transmission mode for transmitting the image data obtained by the radiation image detector 3 to the console 4 from three options including transmission in a wireless mode from the communication unit 17, transmission in a wired mode through the connecting terminal 18 and transmission by removing the attachable/removable memory 6 from the radiation image detector 3 and then attaching it directly to the console 4, and can transmit a radiation image to an external apparatus in any of the three modes, that is, the wireless mode, the wired mode and through the attachable/removable memory 6. As a result, it is possible to select the wireless mode that is needless of the cable connection and easy to handle, and it is also possible to safely generate images of the patient 30 who is wearing a medical device such as a pacemaker by changing over the transmission mode into the wired mode, or the transmission through the attachable/removable memory 6, in which harmful electromagnetic waves are not generated. In addition, even when a situation where any of the foresaid transmission modes is disabled has arisen, such as the case where a wireless communication is disabled due to communication disturbance and the like, it is possible to immediately change over the transmission mode into the other mode to thereby transmit an image data.

Furthermore, the degree of freedom in the system configuration can be increased because it is possible to arbitrarily select a transmission mode from a plurality of transmission modes, that is, the mode to transmit an image data from the communication unit 17, the mode in which a cable is connected to the connecting terminal 18 to thereby transmit an image data through the cable, and the mode to transmit an image data by attaching the attachable/removable memory 6 directly to the console 4.

In this embodiment, although it is configured such that the radiation image detector 3 is connected with an external apparatus such as the console 4 by connecting a cable to the connecting terminal 18 to thereby transmit an image data, it may also be configured such that, for example, the connecting terminal 18 of the radiation image detector 3 is electrically connected with the connecting terminal provided at the cradle side by loading the radiation image detector 3 on the cradle to be connected to an external apparatus such as the console 4 to thereby enable to transmit an image data. The cradle contains, for example, a terminal to be connected at the time of loading the radiation image detector 3 with the connecting terminal 18 at the position corresponding to the connecting terminal 18 of the radiation image detector 3 and is connected to the console 4 in a wireless mode using various electric waves, light and so on or in a wired mode using a cable or the like. In this case, for example, it may also be configured such that, upon completion of loading the radiation image detector 3 on the cradle and establishment of a connection of the connecting terminal 18 to the connecting terminal provided at the cradle side, the control unit 12 then selects the transmission mode through the connecting terminal 18 to transmit an image data via the connecting terminal 18 and the cradle.

When the radiation image detector 3 and the console 4 are connected to each other through the cradle as described above, the cradle may have a function as a charger for charging the rechargeable battery 21 of the power source 20 in the radiation image detector 3. In this case, the cradle is provided with a connector (not shown), and the rechargeable battery 21 in the radiation image detector 3 is charged at the time the connector and the radiation image detector 3 are connected. On this occasion, the cradle is preferably formed such that the radiation image detector 3 can be easily attached and removed. Further, the cradle may have a function as a holder during no use of the radiation image detector 3 in addition to the function as a charger for the radiation image detector 3.

Further, a change-over switch, similarly to that described in the second embodiment, is provided to permit a user to arbitrarily set a transmission mode for transmitting an image data to the console 4 in the wireless mode from the communication unit 17, or in the wired mode through the connecting terminal 18, or in the mode of transmitting by removing the attachable/removable memory 6 from the radiation image detector 3 and then attaching it directly to the console 4.

Note that, similarly to the second embodiment, the present invention is not limited to this embodiment.

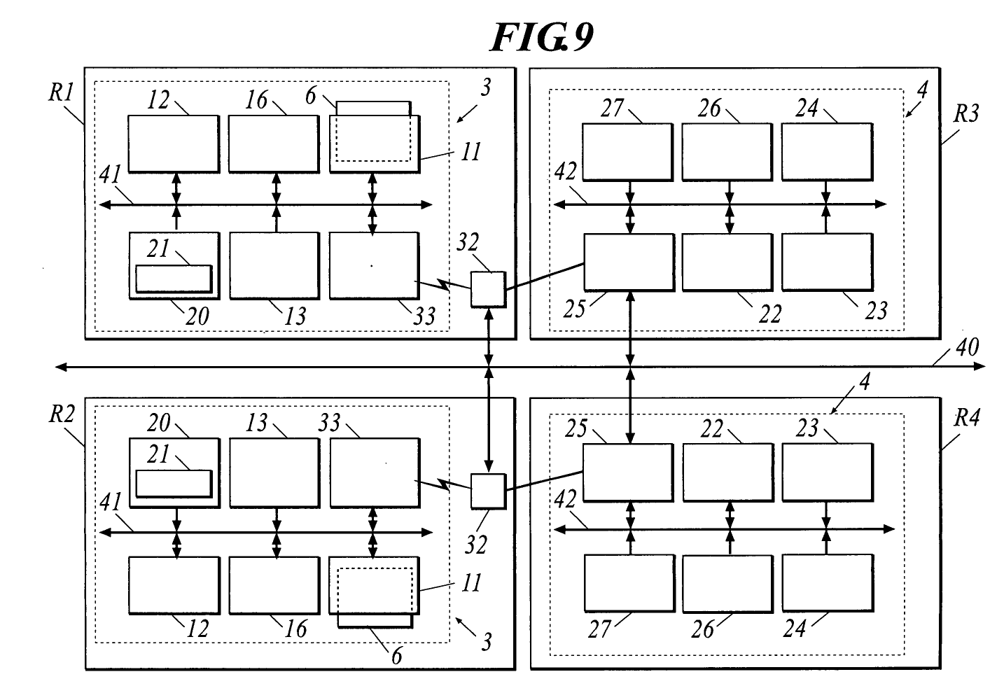

Now, the fourth embodiment for the radiation image detector and the radiation image generating system according to the present invention will be explained in the following with referring to FIG. 9. Note that, in the following, only particular aspects being different from those described in the first to third embodiments are explained.

In the first place, as shown in FIG. 9, the radiation image generating system according to the fourth embodiment is an image generating system, that is assumed to be used for radiation image generations in a hospital, and is placed in, for example, radiation image generation rooms R1 and R2, wherein radiation is irradiated to a patient, and radiation control rooms R3 and R4 for controlling radiation to be irradiated to a patient by a radiologic technologist, image-processing of radiation images obtained by the irradiation of radiation and so on. Note that, although it is configured in FIG. 9 such that there are two radiation image generation rooms and two radiation control rooms, the numbers of these rooms are not limited to the numbers in this example, and it may also be configured such that a plurality of rooms may be provided for the respective room, or just one may be provided for the respective room.

In each of the radiation control rooms R3 and R4, the console 4 is provided. In this embodiment, the console 4 can cause transmissions and receptions of various information between the radiation image detector 3 and the other external apparatus to be described later, and the consoles 4 controls the overall radiation image generating system, thereby the radiation image generation is controlled, and image-processing of the obtained radiation images are performed.

Similarly to the first embodiment, the console 4 contains a control unit 22, the ROM 23, the RAM 24, the communication unit 25, the input operation unit 26 and so on, and the respective components are connected one another through the bus 42.

The respective communication unit 25 is connected with, for example, a radio relaying apparatus 32 described later via the network 40, can communicate with the radiation image detector 3 via the radio relaying apparatus 32, and can receive an image data transmitted from the radiation image detector 3 and the other various information in a wireless mode.

Note that, although it is described that the console 4 is installed in the radiation control rooms R3 and R4, respectively, in the description given above, the console 4 may be a portable terminal capable of executing radio communication. In such a case, it is preferable that a radio relaying apparatus is installed as well in the radiation control rooms R3 and R4, respectively, and the communication unit 25 can radio-communicate with the radio relaying apparatuses 32 in the radiation image generating rooms R1 and R2 and the radio relaying apparatuses in the radiation control rooms R3 and R4, thereby the communication unit 25 can communicate in both the radiation image generating rooms R1 and R2 and the radiation control rooms R3 and R4 with the radiation image detector 3. As a result, an operator to generate radiation images can check radiation images with the console 4 not only in the radiation control rooms R3 and R4 as in the past but also in the radiation image generating rooms R1 and R2 while giving instructions on the image generating position, etc. to the image generation subject and start image-processing of radiation image data. Furthermore, an operator can check the radiation images and start image-processing of radiation image data during the time having been spent for moving between the radiation image generating rooms R1 and R4 and the radiation control rooms R3 and R4, thereby the image generation efficiency in total over the image generation operation where a cycle consisting of procedures from image generation until checking of radiation images is repeated can be improved.

In the respective radiation image generating rooms R1 and R2, a radiation source (not shown) for irradiating radiation to a patient, a radiation image detector 3 similarly to those described in the first to third embodiments, and the radio relaying apparatus 32 for relaying communication between the radiation image detector 3 and the console 4 are installed.

Similarly to the first embodiment, for example, the control unit 12, the planar detection unit 13, the image memory 16, the storing section attachment part 11, a communication unit 33, the power source 20 provided with the rechargeable battery 21, a RAM (not shown) and a ROM (not shown) are provided in the radiation image detector 3, and these components are connected one another through the bus 41.

The communication unit 33 is connected to the network 40 via the radio relaying apparatus 32, and can transmit and receive various signals in a wireless mode between itself and an external apparatus such as the console 4 via the radio relaying apparatus 32 and the network 40.

The radio relaying apparatus 32 is connected to the network 40, for example via a cable, and can communicate with the plurality of consoles 4 and the other external apparatus being connected to the network 40. Then, various signals transmitted from the consoles 4 are received by the radiation image detector 3 through the radio relaying apparatus 32, or the image data and various signals are transmitted to the consoles 4.

The communication cable connecting the radio relaying apparatus 32 and the network 40 is preferably attachable and removable.

Further, in this embodiment, the radio relaying apparatus 32 may have a function as a charger for charging the rechargeable battery 21 of the power source 20 in the radiation image detector 3. In this case, the radio relaying apparatus 32 is provided with a connector (not shown), and the rechargeable battery 21 in the radiation image detector 3 is charged in response to the connecting of this connector with the radiation image detector 3. On this occasion, the radio relaying apparatus 32 is preferably formed such that the radiation image detector 3 can be easily attached and removed. Further, the radio relaying apparatus 32 may have a function as a holder during no use of the radiation image detector 3 in addition to the function as a charger.

Since the other configurations are mostly identical to those described in the first to third embodiments, like reference signs are given to like parts to thereby omit explanations for those parts.

Now, radiation image generation operations with the radiation image generating system to which the radiation image detector 3 according to the present invention is applied will be described in the following.

When the radiation image detector 3 has obtained an image data, the obtained data is temporarily stored in either the image memory 16 or the attachable/removable memory 6.

Then, the control unit 12 selects to transmit in a wireless mode the image data obtained by the radiation image detector 3 to the console 4 or to transmit the data by removing the attachable/removable memory 6 from the radiation image detector 3 and then attaching it directly to the console 4.

Specifically, the control unit 12 determines whether the communication unit 17 is in a normal condition to communicate with the console 4 or not. When it is determined that the communication unit 17 can communicate, the control unit 12 selects a wireless mode through the communication unit 17 as the transmission mode and causes to transmit the image data from the communication unit 17 to the console 4 through the radio relaying apparatus. When the communication unit is disabled to perform the communication, the control unit 12 further determines whether the attachable/removable memory 6 is attached to the storing section attachment part 11 or not. When it is determined that the attachable/removable memory 6 is attached, the control unit 12 selects the transmission mode where the transmission is performed by removing the attachable/removable memory 6 from the radiation image detector 3 and then attaching it directly to the console 4. When the attachable/removable memory 6 is not attached to the storing section attachment part 11, a display indicating the memory 6 being not attached may be informed to a user by, for example, displaying the indication on the display unit (not shown).

As described above, according to this embodiment, the control unit 12 can select, as the transmission mode for transmitting the image data obtained by the radiation image detector 3, either the mode to transmit from the communication unit 17 in a wireless mode or the mode to transmit by removing the attachable/removable memory 6 from the radiation image detector 3 and then attaching it directly to the console 4. As a result, it is possible to select the wireless mode that is needless of the cable connection and easy to handle, and to safely generate images of the patient 30 who is wearing a medical device such as a pacemaker by changing over the transmission mode into the transmission through the attachable/removable memory 6, which does not generate harmful electromagnetic waves. In addition, even when a situation where the transmission from the communication unit 17 in a wireless mode is disabled has arisen, such as the case where a wireless communication is disabled due to communication disturbance and the like, it is possible to immediately change over the transmission mode into the other mode to thereby transmit an image data.

Furthermore, according to this embodiment, the radio relaying apparatus 32 is installed respectively in the radiation image generating rooms R1 and R2, and the radiation image detector 3 and an external apparatus such as the console 4 communicate with each other via the radio relaying apparatus 32. Thus, radio communication in a good condition can be attained between the radiation image detector 3 and an external apparatus such as the console 4 even when the radiation image detector 3 is used in the radiation image generating rooms R1 and R2 which are isolated with use of a radiation-blocking material. Furthermore, even when microwaves or light with strong rectilinear and directional properties is used for the communication, it is possible to perform radio communication in a good condition without causing communication disturbance by carrying out the communication through the radio relaying apparatus 32. As a result, it is possible to transmit radiation image data with a large capacity at high speed and efficiently and to accordingly further improve the image generation efficiency.

Although it is configured in this embodiment such that the transmission mode for transmitting an image data from the radiation image detector 3 to the console 4 includes the transmission mode to transmit from the communication unit 17 in a wireless mode and the mode to transmit by removing the attachable/removable memory 6 from the radiation image detector 3 and then attaching it directly to the console 4, it may also be configured, similarly to the third embodiment, such that a connecting terminal capable of connecting with a cable or a cradle to be connected with the console 4 is provided, and an image data is transmitted from the radiation image detector 3 to the console 4 in a wired mode through the connecting terminal.

Alternatively, similarly to the second embodiment, it may also be configured such that a change-over switch is provided to permit a user to arbitrarily select the transmission mode for transmitting an image data to the console 4 from the transmission from the communication unit 17 in a wireless mode, the transmission through the connecting terminal 18 in a wired mode, and the transmission by removing the attachable/removable memory 6 from the radiation image detector 3 and then attaching it directly to the console 4.

Note that, similarly to the first to third embodiments, the present invention is not limited to this embodiment.

The entire disclosure of Japanese Patent Application No. Tokugan 2004-212931 which was filed on Jul. 21, 2004, including specification, claims, drawings and summary is incorporated herein by reference in its entirety.

What is claimed is:

1. A radiation image detector comprising:
a radiation image obtaining section to detect radiation irradiated and obtain a radiation image data;
a communication unit to transmit the radiation image data to an external apparatus;
a storing section attachment part which is capable of removably holding a storing section for storing the radiation image data, and causes the attached storing section to preserve the radiation image data obtained by the radiation image obtaining section; and
a control unit that to select whether to transmit the radiation image data from the communication unit or to transmit the radiation image data by using the storing section,
wherein the control unit changes over a transmission mode for transmitting the radiation image data to the external apparatus based on a result of the selection.

2. The radiation image detector of claim 1, wherein the communication unit performs communication in a wireless mode.

3. The radiation image detector of claim 2, wherein the wireless mode uses microwave or light.

4. The radiation image detector of claim 1, further comprising a connecting terminal to be connected directly or indirectly to the external apparatus and connected with a cable for transmitting the radiation image data.

5. The radiation image detector of claim 1, further comprising a connecting terminal to be connected directly or indirectly to the external apparatus and connected with a cradle for transmitting the radiation image data.

6. The radiation image detector of claim 4, wherein, when the cable is attached to the connecting terminal, the control unit causes to transmit the radiation image data from the connecting terminal.

7. The radiation image detector of claim 5, wherein, when the cradle is attached to the connecting terminal, the control unit causes to transmit the radiation image data from the connecting terminal.

8. The radiation image detector of claim 1, wherein a change-over switch for changing over a transmission mode between at least a mode to transmit from the communication unit and a mode to transmit by the storing section is provided, and the control unit causes to transmit the radiation image data from either the communication unit or the storing section in response to the changing-over of the change-over switch.

9. The radiation image detector of claim 1, wherein, when a signal for changing over a transmission mode for transmitting a radiation image data between a mode to transmit from the communication unit and a mode to transmit by the storing section was sent from the external apparatus, the control unit causes to transmit the radiation image data from the communication unit or the storing section in accordance with the signal.

10. The radiation image detector of claim 1, further comprising an image memory to store the radiation image data.

11. The radiation image detector of claim 1, wherein the radiation image detector includes a flat panel detector (FPD) to detect radiation which was irradiated and to convert the radiation into an electric signal to obtain the radiation image data.

12. The radiation image detector of claim 1, further comprising an internal electrical power source to supply electric power to at least the radiation image obtaining section and the control unit.

13. A radiation image generating system comprising:
the radiation image detector of claim 1; and
a console to operate the radiation image detector,
wherein the console comprises a communication unit to communicate with an external apparatus, and receives a radiation image data when the console was connected with either the communication unit provided in the radiation image detector or a storing section removably held by a storing section attachment part.

14. The radiation image generating system of claim 13, further comprising a radio relaying apparatus to relay a radio signal to be transmitted and received between the communication unit in the radiation image detector and the communication unit in the console.

15. The radiation image generating system of claim 14, further comprising a plurality of image generating rooms, in each of which the radiation image detector and the radio relaying apparatus are disposed, and a plurality of radio relaying apparatuses and a plurality of consoles in the plurality of image generating rooms are connected one another through a network.
